(19) United States
(12) Patent Application Publication
(10) Pub. No.: US 2012/0235012 A1
(43) Pub. Date: Sep. 20, 2012

(54) STAND FOR A VERTICALLY EXTENDING OBJECT HAVING A POLE-LIKE BOTTOM PORTION

(76) Inventor: Dale Andrassy, Hudson, OH (US)

(21) Appl. No.: 13/048,933

(22) Filed: Mar. 16, 2011

(51) Int. Cl. F16M 11/22

(52) U.S. Cl. 248/523

(57) ABSTRACT

A stand for supporting a vertically extending object includes a base defining a recess having a center axis for receiving a bottom portion of the vertically extending object, and defining at least one slot. The stand further includes at least one wedge portion comprising an inward facing side, and the wedge portion is moveable within the slot. When the wedge portion is moved downward in the slot, the inward facing side moves inward toward the center axis of the recess until the inward facing side of the wedge portion presses against the bottom portion of the vertically extending object to secure the vertically extending object within the base. The vertically extending object may be a Christmas tree or similar object with a pole or pole-shaped bottom portion. A stand/object assembly includes the described stand and the vertically extending object.

### TECHNICAL FIELD OF THE INVENTION

The technology of the present disclosure relates generally to a stand for a vertically extending object having a pole-like bottom portion, such as, for example, a stand for a Christmas tree.

### DESCRIPTION OF THE RELATED ART

Every holiday season, people from all over the country (if not the world) participate in the annual Christmas ritual of setting up the Christmas tree. In conventional set-ups, the Christmas tree trunk is inserted into a conical stand. The conical stand typically has a cylindrical recess for receiving the tree trunk.

The cylindrical recess is designed so as to be wider than an expected width of a Christmas tree trunk so the trunk can be inserted into the recess with minimal effort. The tree trunk, therefore, must be secured tightly into the cylindrical recess of the stand to prevent the tree from toppling over. Tree trunks, of course, often have differing width diameters. The tightening system of the stand, therefore, must be sufficiently adaptable to accommodate varying sized tree trunks. Even for those who would dare utilize a fake or artificial tree, the recess for receiving the pole-like bottom portion of an artificial tree still must be secured tightly into the recess.

Conventional Christmas tree stands are provided with a plurality of flat faced set screws, typically as least three or more. The upper portion of the conical sides of the stand is provided with through-holes spaced about the circumference of the stand for receiving the set screws. To secure the tree in the stand, the tree trunk is inserted into the cylindrical recess. One by one, the set screws are then screwed through the through-holes until the flat faces of the screws are pressed tightly against the tree trunk. With the set screw faces pressed tightly against the tree trunk, the Christmas tree is supported securely in the stand.

To obtain an optimum secured position, it is preferable that the set screws each penetrate the cylindrical recess by a substantially equal distance and press against the tree with a substantially equal force. Imbalances in the alignments and force of the set screws relative to each other can cause the tree to lean in the stand. Such leaning is aesthetically undesirable, and increases the risk the tree will topple particularly during the placement of ornaments and decorations. A user, therefore, often must adjust each screw repeatedly, moving the screws in and out until the various screws are properly aligned. Such operation often requires at least two people—one person to hold up the tree in the recess while the second person adjusts the screws. The more set screws available to support the tree, the more secure the tree will be in the stand. Increasing the number of screws, however, increases the tediousness of the effort needed for proper alignment.

In addition, because the set screws are driven against the tree trunk, they can cause damage if driven inward too far or with too much force. For example, the set screws may cause cracking or splintering of a natural tree trunk, or denting of an artificial tree trunk. Conventional set-screw Christmas tree stands, therefore, are deficient in that they are difficult to adjust in a manner that eliminates leaning, and can damage the tree.

### SUMMARY

To improve the consumer experience with vertically extending objects having a pole-like bottom portion, such as a Christmas tree for example, there is a need in the art for an improved stand for such objects. The stand of the current disclosure provides for an enhanced secured, vertical positioning of the vertically extending object, while additionally reducing the hassles and potential damage associated with conventional set screw stands.

In accordance with embodiments of the present invention, a stand for supporting a vertically extending object includes a base defining a recess having a center axis for receiving a bottom portion of the vertically extending object, and defining at least one slot. The stand further includes at least one wedge portion comprising an inward facing side, and the wedge portion is moveable within the slot. When the wedge portion is moved downward in the slot, the inward facing side moves inward toward the center axis of the recess until the inward facing side of the wedge portion presses against the bottom portion of the vertically extending object to secure the vertically extending object within the base. The vertically extending object may be a Christmas tree or similar object with a pole, pole-like, or pole-shaped bottom portion.

A stand/object assembly includes the described stand and the vertically extending object.

In exemplary embodiments, to aid in the moveability of the wedge portion within the slot to secure the vertically extending object within the recess, the base is a conical base that has an inner face defining the recess, and the inner face and the slot are slanted inward toward the center axis at an angle relative to a vertical normal line. The wedge portion has an outward facing side that is slanted inward at the same angle as the slot of the conical base relative to a vertical normal line. The wedge shape results in the motion of the inward facing side of the wedge portion toward the center axis of the recess until the inward facing side of the wedge portion presses against the bottom portion of the vertically extending object.

In exemplary embodiments, the base has at least one screw recess for receiving at least one set screw. The wedge portion has an outward facing side having a plurality of dimples, and the set screw is turned to drive the set screw to the outward facing side such that a face of the set screw cooperates with one of the plurality of dimples. The at least one set screw may be a quick-driving set screw having four screw threads or less.

These and further features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the claims appended hereto.

Features that are described and/or illustrated with respect to one embodiment may be used in the same way or in a similar way in one or more other embodiments and/or in combination with or instead of the features of the other embodiments.

### BRIEF DESCRIPTION OF THE DRAWINGS

FIG. 1 is a schematic diagram depicting a Christmas tree supported in a stand in accordance with exemplary embodiments of the present invention.

FIG. 2 is a schematic diagram depicting a side cross-sectional view of an exemplary conical base of a stand in accordance with embodiments of the present invention.

FIG. 3 is a schematic diagram depicting a top view of the conical base of FIG. 2.

FIG. 4 is a schematic diagram depicting a side cross-sectional view of an to exemplary wedge portion of a stand in accordance with embodiments of the present invention.

FIG. 5 is a schematic diagram depicting a view of the wedge portion of FIG. 4 toward an inward facing side.

FIG. 6 is a schematic diagram depicting a view of the wedge portion of FIG. 4 toward an outward facing side.

FIG. 7 is a schematic diagram depicting an exemplary set screw and associated nut of a stand in accordance with exemplary embodiments of the present invention.

FIG. 8 is a schematic diagram depicting a side cross-sectional view of an exemplary stand in accordance with embodiments of the present invention, in which the wedge portions of the stand are in a first position relative to the conical base of the stand.

FIG. 9 is a schematic diagram depicting the stand of FIG. 8, in which the wedge portions of the stand are in a second position relative to the conical base of the stand.

### DETAILED DESCRIPTION OF EMBODIMENTS

Embodiments of the present invention will now be described with reference to the drawings, wherein like reference numerals are used to refer to like elements throughout. It will be understood that the figures are not necessarily to scale.

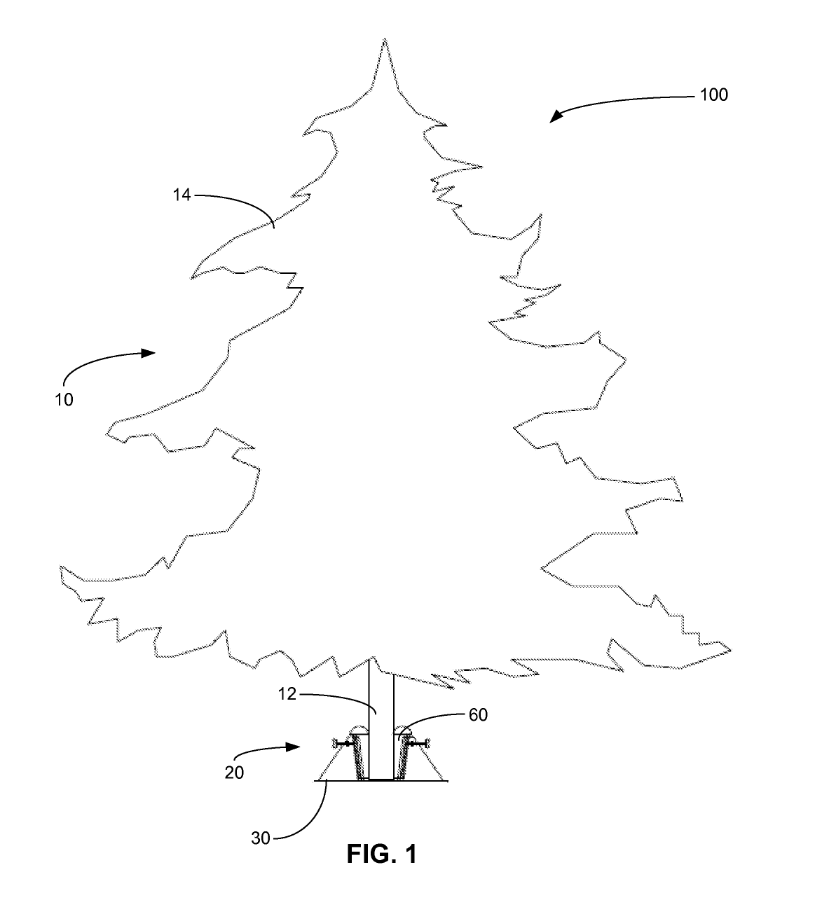

FIG. 1 is a schematic diagram depicting an exemplary stand/object assembly 100 including a vertically extending object 10 and a stand 20. The vertically extending object 10 may include a pole, pole-like, or pole-shaped bottom portion 12.

In exemplary embodiments, the vertically extending object 10 may be a Christmas tree having a pole-like bottom portion 12 in the form of the tree trunk and an upper foliage portion 14. The Christmas tree either may be a natural tree or an artificial tree as is conventional. The Christmas tree 10 is secured into the stand 20, the stand 20 having a recess for receiving the trunk 12. As used herein, therefore, the term “bottom portion” as used in connection with describing a vertically extending object would generally refer to a portion of a vertically extending object that is received within the stand, such as, for example, a tree trunk that extends from below an upper portion of the tree containing the foliage. Although the present invention largely is described in connection with supporting a Christmas tree, it will be appreciated the stand may be employed to support any vertically extending object having a pole, pole-like, or pole-shaped bottom portion. Additional examples of such objects may include floor-standing flags, sign posts, floor standing speakers, and the like. The stand 20 is configured to support the Christmas tree 10 in a substantially vertical manner with minimal leaning. As further describe below, the stand 20 includes a base 30 and at least one wedge portion 60.

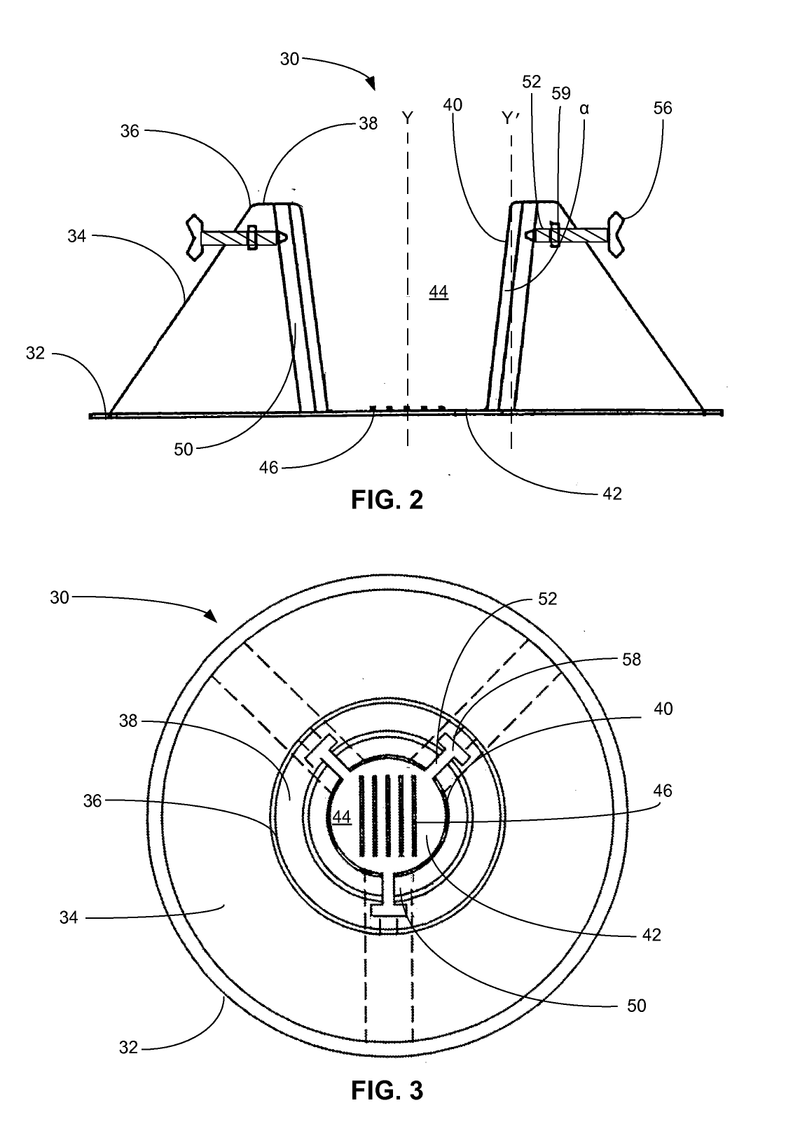

FIG. 2 is a schematic diagram depicting a side cross-sectional view of the base 30 of the stand 20 of FIG. 1. FIG. 3 depicts a top view of the base 30 of FIG. 2. Although various shaped bases may be employed, the base in the described stand generally is referred to as a conical base. Conically-shaped bases typically provide better support as to compared to other shaped bases (e.g., cubic, rectangular prism, or cylindrical), which tend to have a greater propensity for toppling over. As seen in FIGS. 2 and 3, the conical base 30 may include a bottom flat edge or bottom 32 from which there extends conically inward and upward a conical dish 34. The conical dish 34 extends conically to an edge 36. A horizontal top portion 38 extends radially inward in a substantially horizontal manner from the edge 36. In this way, the edge 36 may be in the form of a ninety-degree or rounded corner between the conical dish 34 and the horizontal top portion 38.

As seen in FIG. 2 in particular, the conical base 30 may be symmetrical about a center axis Y. The conical base has an inner face 40 that defines a recess 44, with the center axis of the conical base also being a center axis of the recess. The inner face 40 may slant inward toward the center axis at an angle α with respect to a vertical normal line Y′ perpendicular to the horizontal top portion 38 (and parallel to the center axis Y). The inner face 40 is represented in FIG. 3, the top view, as the inner ring denoted by the same reference numeral 40, which extends to a central bottom 42 of the base. In exemplary embodiments, the angle α is at least seven degrees, although the precise angle may be varied. The inner face 40 of the conical base 30 defines a recess 44 for receiving the pole, pole-like, or pole-shaped bottom portion of a vertically extending object, such as, for example, the trunk 12 of the Christmas tree 10 of FIG. 1.

Referring again to FIGS. 2 and 3, a central bottom 42 of the conical base 30, which in part defines the recess 44, may have a plurality of ridges 46 forming a ridged contact surface for receiving the trunk 12. In exemplary embodiments in which the vertically extending object is in fact a natural Christmas tree, the conical base 30 may constitute a water containing structure for holding water to reduce drying out of the tree. In particular, the conical dish 34 of the base may include one or more cavities for holding water, which may continuously be provided to the recess 44 to supply water to a supported tree. In such an embodiment, the ridges 46 may provide spaces for permitting the holding of water adjacent the bottom of the tree trunk to keep the tree hydrated.

The conical base 30 defines at least one slot 50 for receiving the at least one wedge portion 60 (not shown in FIGS. 2 and 3). The slots 50 are formed adjacent the inner face 40 and between the inner face 40 and the remainder of the horizontal top portion 38. The slots extend through the conical base 30 from the top portion 38 to the bottom portion 32, and the slots may be slanted inward toward the center axis commensurately with the slant of the inner face 40. Thus, the slots may extend from the top portion to the bottom portion through the conical base at a location outward relative to the center axis as compared the inner face. It has been found that three slots (and thus three wedge portions) provide for adequate securing of the tree, although the precise number of slots (and corresponding wedge portions) may be varied. The positioning of the wedge portions 60 within the slots 50 is described in more detail below.

In exemplary embodiments, the recess 44 may be a substantially cylindrical recess as seen in FIGS. 2 and 3. The term “substantially” is applicable because the straightness of the side boundaries of the cylindrical recess is subject to the slant of the inner face 40. A substantially cylindrical recess is suitable because Christmas tree trunks and the bottom portions of comparable vertically extending objects often have cylindrical pole-like bottom portions.

Optionally, the conical base 30 additionally may include at least one screw recess 52 for receiving at least one set screw 56. In exemplary embodiments, the number of screw recesses and set screws will be equal to the number of slots for receiving the wedge portions. As further described below, the set screws in the described system operate differently from the set screws of conventional stands. In particular, the set screws 56 do not contact the tree trunk, but are configured to cooperate with the wedge portions 60 to aid the wedge portions in securing the tree. The use of the set screws 56 is optional, for the wedge portions 60 under most circumstances provide for a securing configuration that is more than sufficient. The screw recesses 52 may each include a nut slot 58 for receiving a nut 59. Each nut 59 aids in the positioning and holding of a corresponding set screw 56.

The dimensions of the conical base 30 and its associated features may be sized so as to accommodate the desired tree size. For typically-sized household trees, the conical base 30 may have an outer diameter of approximate 1-2 feet with the recess having an inner diameter of approximately five to seven inches. The height of the conical base may range from about half to two-thirds its outer diameter. In configurations suitable for typical household trees, trees of trunk diameters as little as 2.75 inches and as large as six inches may be effectively supported. Of course, these dimensional are exemplary, and essentially any reasonable size smaller or larger than the above may be provided to accommodate a commensurately sized tree. For example, the conical base may be sized up for trees utilized in shopping centers and malls, which usually are larger than typical household trees. Conversely, the conical base may be sized smaller for table-top style decorative trees. It will be appreciated, therefore, that the dimensions may be varied widely.

The conical base 30 may be formed of any material commonly used in conventional Christmas tree stands and stands for similar objects with a pole, pole-like, or pole-shaped bottom portion. Molded rigid plastic materials work particularly well because they are easy to manufacture and handle by the user. Any rigid material suitable for a stand or support, however, may be employed, such as metals, woods, various rigid plastics, and similar materials.

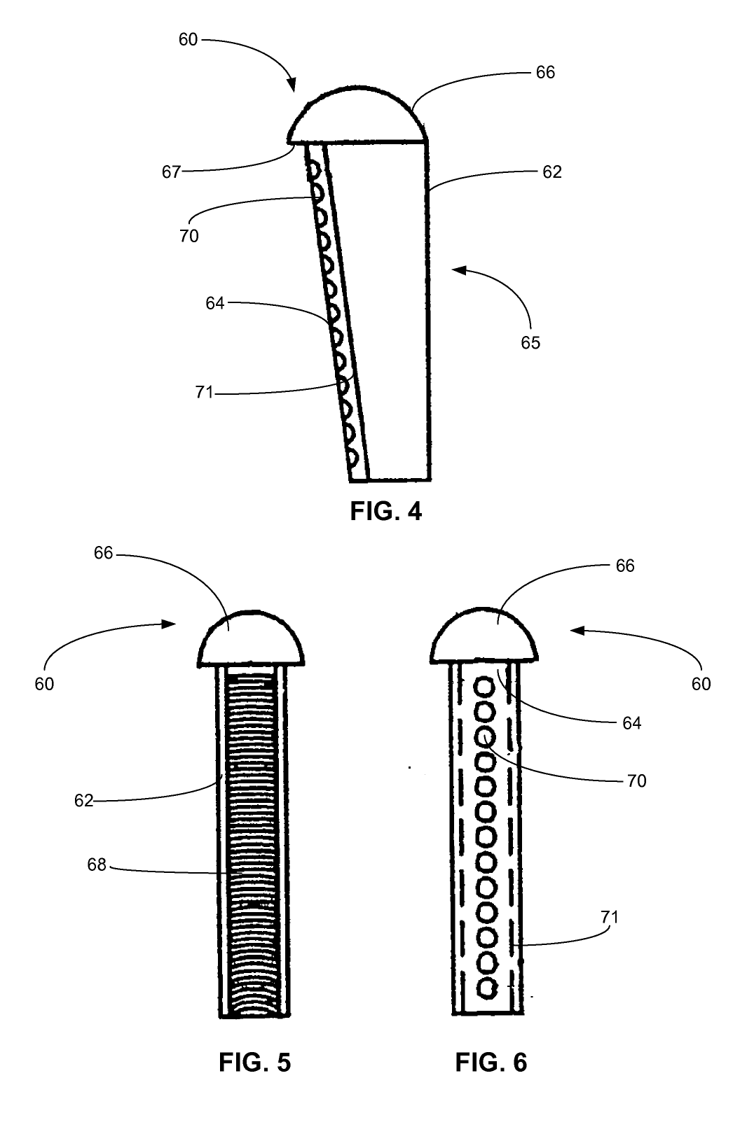

FIGS. 4-6 are schematic diagrams depicting the configuration of an exemplary wedge portion 60 for use in the stand 20. In particular, FIG. 4 depicts a side cross-sectional view of the wedge portion 60, FIG. 5 depicts a view of the wedge portion 60 toward an inward facing side 62, and FIG. 6 depicts a view of the wedge portion 60 toward an outward facing side 64. When the recess 44 is substantially cylindrical, the inward facing side 62 may be referred to as a radially inward facing side, and the outward facing side 64 may be referred to as a radially outward facing side.

Referring to FIG. 4, the inward facing side 62 of the wedge portion 60 may be a straight vertical, or substantially vertical, surface. The outward facing side 64 is on the opposite side of the wedge portion 60 relative to the inward facing side 62. In this context, the orientation of the sides refers to the general facing direction of a side relative to the center axis Y of the conical base and recess when the wedge portion is in use. The outward facing side 64 may be slanted by the angle α with respect to a vertical normal line commensurately with the orientation of the slot and inner face of the conical base as described above. In exemplary embodiments, as stated above, the angle α may be at least seven degrees, although again the precise angle may be varied. The wedge portion 60 also may include a head 66 that provides a contact surface for applying a force to drive the wedge portion downward in the slot of the conical base, as further explained below.

The dimensions of the wedge portions 60 may be sized commensurately with the dimensions of the conical base described above. For example, the part of the wedge portion including the sides 62 and 64 may form a lower wedge portion 65, which may be sized to be approximately the height of the recess 44 within the conical base 30. In the typical household tree configuration, the head 66 may be a rounded or semi-circular shape having a radius of approximately 1-1.5 inches, and would rest atop the lower wedge portion 65 as seen in FIG. 4 for example. The head 66 may include a lip 67 that extends at least approximately a half inch beyond the upper edge of the outward facing side 64. In this manner, referring back to FIG. 1 for example, in use the lower wedge portions may maximally extend essentially the all the way down into the recess of the base, with the lips of the heads of the wedge portions resting on the horizontal top portion of the conical base. The lip 67 configured in this manner is strong enough to withstand the pounding force on the head 66 without breaking upon impacting the top 38 of the conical base 30. In addition, as further described below, the lip 67 provides a surface for dislodging the wedge portion 60 out of the securing position with a claw hammer back or similar prying device.

The maximum width of the lower wedge portion 65 may be sized to about a quarter to half the radius of the inner radius of the conical base defining the recess 44. In this manner, at least half of the inner recess may be employed to accommodate the tree trunk. Such configuration permits supporting a wide range of tree trunk sizes without compromising the effectiveness of the support. Similarly as with respect to the conical base 30, the dimensions of the wedge portions 60 described above may be varied widely, and the dimensions may be sized to any reasonable size smaller or larger to accommodate a commensurately sized tree.

The wedge portions 60 may be formed of any materials similar to those used to form the conical base 30. For example, molded rigid plastic materials also work particularly well for forming the wedge portions 60 because they are easy to manufacture and handle by the user. Again, any rigid material suitable for a stand or support, however, may be employed, such as metals, woods, various rigid plastics, and similar materials. The head 66 of the wedge portions may be formed of either the same material as, or a material different from, the lower wedge portion 65. In exemplary embodiments, the material of the head 66 of the wedge portion is a hard rubberized or similar semi-rigid material with sufficient resiliency to accommodate a pounding force. In this manner, the user may pound the head 66 with a hammer, mallet, or like instrument without denting, cracking, or otherwise damaging the head 66 or the other sections of the wedge portion 60.

As seen in FIG. 5, the inward facing side 62 may include a gripping surface 68. The gripping surface 68 may be a grooved or textured surface that, when in use, contacts the tree trunk. The grooves or texture of the gripping surface 68 may aid in providing a high-friction junction with the tree trunk so as to enhance the securing force. The gripping surface 68 may be formed or molded contiguously as part of the wedge portion 60. Alternatively, the gripping surface may be added as an additional layer applied to the inward facing side 62. In exemplary embodiments, the gripping surface 68 may be made of a resilient material, such as a resilient plastic, foam, rubber, silicone or like material. The resiliency of the gripping surface 68 may provide a sealing type force to aid in securing the tree trunk, and would also prevent damage to the tree trunk (or other pole-like bottom portion) that otherwise commonly may occur in conventional systems when set screws are driven against the trunk.

As seen in FIG. 6, the outward facing side 64 may include a plurality of dimples 70. In exemplary embodiments, the dimples 70 may be oriented in a vertical line along the outward facing side 64, with each dimple being spaced about one half inch apart. It will be appreciated the precise configuration of the dimples may be varied. As further explained below, the dimples may cooperate with the optional set screws 56 so as to provide an additional aid in securing the tree trunk within the stand. The outward facing side 64 may further include a ridge or lip 71 for fitting within a cooperating portion of one of the slots 50.

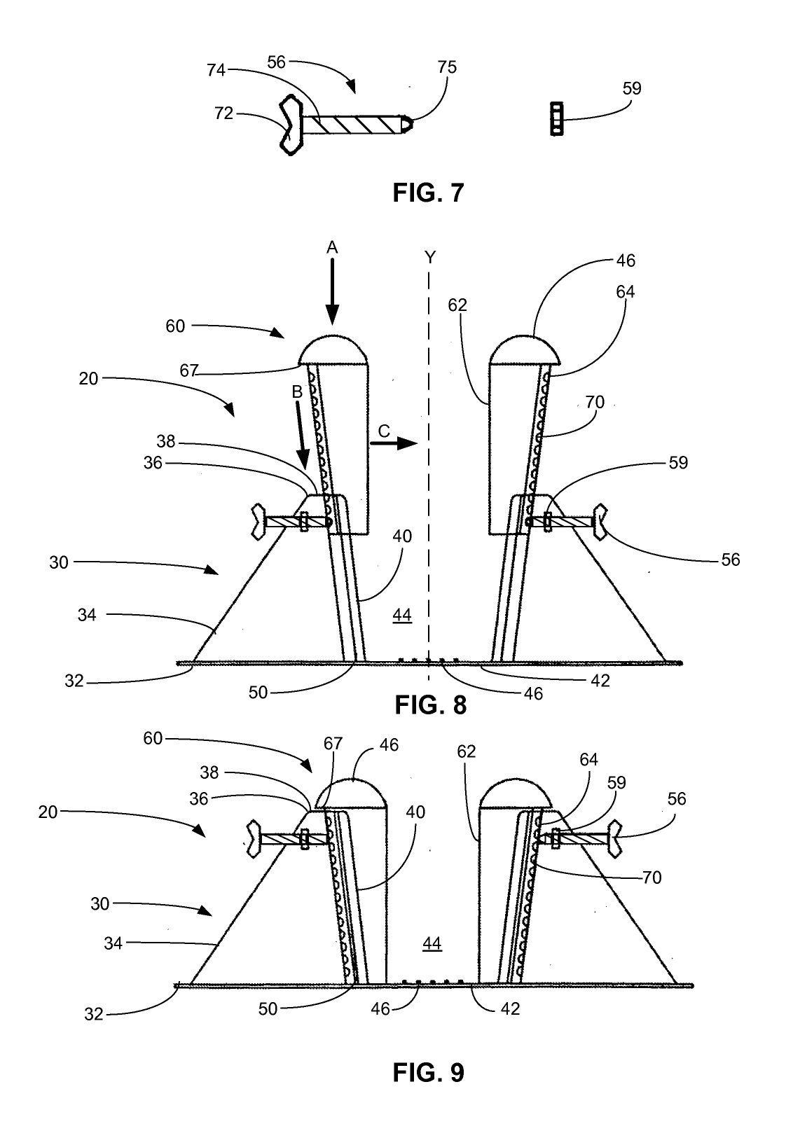

FIG. 7 is a schematic diagram depicting an exemplary set screw 56 and associated nut 59 in accordance with exemplary embodiments in which set screws may be employed. The set screw includes a screw head 72 for turning by the user, threads 74 that cooperate with opposite threads on the nut 59, and a face 75 on an opposite end of the set screw from the screw head. The set screws 56 differ from conventional set screws commonly used in connection with Christmas tree stands. In particular, set screws 56 of the present invention may be quick-driving set screws that may have only four windings or less, and approximately two to four windings, of the threads, as compared to the tens of threads or more typically present on conventional set screws. As further described below, the quick-driving nature of the set screws 56 permits the screws to be driven into place with minimal effort as compared to conventional set screws.

The operation of the disclosed stand 20 will now be described with reference to FIGS. 8 and 9. FIG. 8 depicts a side cross-sectional view of a stand configuration in which the wedge portions 60 of the stand 20 are in a first or initial position relative to the conical base 30 of the stand. FIG. 9 depicts a stand configuration in which the wedge portions 60 of the stand 20 are in a second or securing position relative to the conical base 30 of the stand.

As seen in FIGS. 8 and 9, each wedge portion 60 is moveable in a corresponding slot 50 of the conical base 30. In particular, each wedge portion may be moved downward in the slot from the first position of FIG. 8 to the second position of FIG. 9. For example, a user may drive the wedge portion 60 downward in the slot by using a hammer or mallet to apply a driving force against the rounded head 66. The direction of an exemplary driving force is indicated in FIG. 8 by the arrow A, showing the force being applied in a substantially vertical direction. The driving force of arrow A causes the wedge portion 60 to move downward in the slot in the direction of the arrow B. Because of the commensurately slanted shapes of the wedge portion 60 and the corresponding slots 50, as the wedge portion moves downward within the slot, the inward facing side 62 of the wedge portion 60 moves inward toward the center axis Y of the recess 44. This inward motion is shown by the arrow C in FIG. 8. The wedge portions may be driven to a maximum distance down into the conical base until the rounded head 66 rests on top the conical base, as shown in FIG. 9, with the lip 67 of the head 66 resting on the top 38 of the conical base.

As the plurality of wedge portions 60 are driven into the conical base in the manner described above, the corresponding plurality of inward facing sides 62 are driven inward toward the center axis, thereby reducing the available space within the recess 44. When a tree trunk (or similar pole-like object) is placed within the recess 44, the inward facing sides 62 move inward until such sides press against the bottom portion (the trunk) to secure the tree into position. In an exemplary embodiment in which the recess is substantially cylindrical and the inward facing side of the wedge portion is a radially inward facing side, when the wedge portion is moved downward in the slot, the radially inward facing side moves radially inward toward the center axis of the recess to press against the bottom portion (the tree trunk). The result is the configuration depicted in FIG. 1.

The lip 67 of the wedge portion head 66 and the top 38 of the conical base define a space that permits removal of the wedge portions when the user wishes to remove the tree (or other object) from the stand. For example, a claw hammer back or similar prying object may be inserted between the lip 67 and top 38 to dislodge the wedge portion up and out from the securing position. Typically, once one wedge portion has been dislodged in such a manner, the remaining wedge portions are loosened out of the securing position and may be removed with minimal effort.

Although FIGS. 1 and 9 depict the wedge portions 60 driven into the conical base 30 by the maximum amount, it will be appreciated such often may not be the case. Rather, the amount the wedge portions 60 are driven into the conical base 30 may depend upon the width of the tree trunk. For relatively wider tree trunks, for example, the wedge portions may not need to be driven all the way down into the conical base before the inward facing sides press against and secure the tree trunk. Various intermediate positions may be employed between the initial position of FIG. 8 and the maximum positions of FIGS. 1 and 9 depending upon the width of the tree trunk. Furthermore, each of the wedge portions need not be driven into the conical base by the same amount. It is common in natural trees, for example, that the tree trunk has an irregular surface, and therefore the width may not be uniform. Because of irregularities in the shape of the tree trunk, each wedge portion may be driven into the conical base by a different amount.

The stand described above has advantages over conventional stands employing set screws. In the described stand, the driving force of the hammer or mallet against the wedge portions is a more non-precise, blunt operation as compared to fine tuning set screws. As a result, a single user may be able to hold up the tree with one hand while driving wedge portions with a hammer or mallet. With the conventional system employing only set screws, in which balancing the screw positions is a much finer operation, it is often necessary for one personal to hold up the tree while another fine tunes the positions of the set screws.

In addition, the vertical nature of inward facing sides 62 of the wedge portions 60 provide for enhanced support as compared to conventional set screw configurations. As substantially flat and vertical surfaces, as the inward facing sides press against the tree trunk, such sides tend to self-align the tree in the vertical orientation. Indeed, even if the tree trunk may not be fully centered in the recess 44, the pressing force of sides 62 tends to cause the tree trunk to extend vertically. Any tendency to lean, therefore, is essentially eliminated. In addition, the inward facing sides provide a greater surface area of support as compared to set screw faces, and distribute the supporting force more evenly and over a wider commensurate surface area of the tree trunk. Comparing the typical dimensions of a set screw face (based on approximately a quarter inch diameter) versus the contacting surface area of the inward facing sides of the wedge portions of the present invention, the support surface of the wedge portions may be as great as twenty to thirty times the support surface provided by a group of set screws. Such a configuration, therefore, provides an enhanced support without damaging the tree trunk as compared to the conventional configuration in which set screw faces are driven into the tree trunk. The described stand, therefore, provides for enhanced support without leaning, and with significantly less user effort during setup as compared to conventional configurations.

Referring again to FIGS. 8 and 9, the stand described above optionally may include the additional set screws 56. To employ each set screw, as stated above, a nut 59 may be placed into a nut slot 58 of a screw recess 52 in the conical base 30. A user may turn the screw via the screw head 72 to drive the screw inward toward the center axis of the conical base.

The set screws 56 differ from conventional set screw configurations. Because the wedge portions provide the gravamen of the supporting force, the set screws may be inserted for added support after the wedge portions are in place. This renders the set screws 56 easier to drive into place. Furthermore, the set screws 56, as stated above, are quick-driving screws with, for example, four windings or less, and typically two to four windings, which requires little turning to drive the screws into place. Because the supporting force of conventional set screws is provided mostly by the screws themselves, tight windings are required that necessitate time-consuming turning and fine-tuning by the user to balance the set screw positions. In contrast, set screws 56 of the described stand are driven inward such that a face 75 of the set screw cooperates with one of the dimples 70 of the outward facing sides 64 of the wedge portions 60. The particular dimple into which a face 75 of the set screw is driven will depend upon how far the wedge portions are driven downward based upon the width of the tree trunk. The vertical aligning of the numerous dimples 70, therefore, permits cooperation with the set screws 56 for various widths of tree trunks. Because the positioning the set screws is dictated by the cooperating dimple of the wedge portion, there is no need to repeatedly fine-tune the screw positions as required with conventional set screw stands.

The set screws 56 themselves, therefore, are not a primary supporting element, but merely aid in holding the wedge portions in place at a desired height or level within the recess 44. Indeed, in most circumstances the pressing force of the wedge portions against the trunk would be sufficient to hold the wedge portions and tree trunk in place, and the set screws 56 may not be necessary. Accordingly, the set screws 56 merely provide an additional support structure for an added layer of confidence in the support. In addition, because the faces 75 of the set screws 56 are driven into the cooperating dimples 70 and not into the tree trunk itself, the set screws 56 cannot damage the tree trunk as may happen in conventional configurations.

Although the invention has been shown and described with respect to certain preferred embodiments, it is understood that equivalents and modifications will occur to others skilled in the art upon the reading and understanding of the specification. The present invention includes all such equivalents and modifications, and is limited only by the scope of the following claims.

What is claimed is:

1. A stand for supporting a vertically extending object comprising:
a base defining a recess having a center axis for receiving a bottom portion of the vertically extending object, and defining at least one slot; and
at least one wedge portion comprising an inward facing side, and the wedge portion is moveable within the slot;
wherein when the wedge portion is moved downward in the slot, the inward facing side moves inward toward the center axis of the recess.

2. The stand according to claim 1, wherein the base has an inner face defining the recess, and the inner face and the slot are slanted inward toward the center axis at an angle relative to a vertical normal line.

3. The stand according to claim 2, wherein the wedge portion has an outward facing side that is slanted inward toward the center axis at the same angle as the slot of the base relative to a vertical normal line.

4. The stand according to claim 3, wherein the angle of the slant is at least seven degrees.

5. The stand according to claim 1, wherein the base is a conical base comprising a bottom, a conical dish extending conically upward from the bottom to an edge, and a top portion extending horizontally from the edge toward the center axis of the conical base.

6. The stand according to claim 5, wherein the slot extends from the top portion to the bottom through the conical base.

7. The stand according to claim 6, wherein the conical base has an inner face defining the recess, and the slot extends from the top portion to the bottom of the conical base at a location outward relative to the center axis as compared to the inner face.

8. The stand according to claim 5, wherein a part of the bottom defining the recess has a plurality of ridges.

9. The stand according to claim 1, wherein the recess is substantially cylindrical and the inward facing side of the wedge portion is a radially inward facing side, and when the wedge portion is moved downward in the slot, the radially inward facing side moves radially inward toward the center axis of the recess.

10. The stand according to claim 1, further comprising at least three slots and at least three wedge portions.

11. The stand according to claim 1, wherein the inward facing side of the wedge portion is a vertical side.

12. The stand according to claim 11, wherein the inward facing side of the wedge portion has a gripping surface.

13. The stand according to claim 1, wherein the wedge portion has a rounded head for receiving a pounding force to drive the wedge portion downward in the slot.

14. The stand according to claim 13, wherein the rounded head has a lip, and when the wedge portion is moved downward into the slot by a maximum distance, the lip of the rounded head rests on top of the base.

15. The stand according to claim 1, further comprising at least one set screw, wherein:
the base has at least one screw recess for receiving the at least one set screw;
the wedge portion has an outward facing side having a plurality of dimples; and
the set screw is turned to drive set screw toward the outward facing side such that a face of the set screw cooperates with one of the plurality of dimples.

16. The stand according to claim 15, wherein the set screw is a quick-driving set screw having four screw threads or less.

17. A stand/object assembly comprising:
the stand according to claim 1; and
a vertically extending object having a bottom portion received in the recess of the base and extending vertically upward from the base.

18. The stand/object assembly according to claim 17, wherein the wedge portion is moveable downward in the slot from a first position to a second position, and in the second position the inward facing side of the wedge portion presses against the bottom portion of the vertically extending object to secure the vertically extending object within the recess of the base.

19. The stand/object assembly according to claim 18, further comprising at least on set screw, wherein:
the base has at least one screw recess for receiving the at least one set screw;
the wedge portion has an outward facing side having a plurality of dimples; and
the set screw is turned to drive the set screw toward the outward facing side such that a face of the set screw cooperates with one of the plurality of dimples.

20. The stand/object assembly according to claim 17, wherein the recess of the base is substantially cylindrical and the bottom portion of the vertically extending object is a pole-shaped bottom portion.
